(19) United States
(12) Patent Application Publication
(10) Pub. No.: US 2016/0117777 A1
(43) Pub. Date: Apr. 28, 2016

(54) SYSTEM FOR PROCESSING ACCOUNT DATA IN A DISTRIBUTED SERVER

(71) Applicant: Hartford Fire Insurance Company, Hartford, CT (US)

(72) Inventors: Sandra E. Belcourt, Hamden, CT (US); Julia M. Feldman, West Hartford, CT (US); Steven J. Fernandes, West Hartford, CT (US); Marc J. Natrillo, Avon, CT (US)

(21) Appl. No.: 14/524,589

(22) Filed: Oct. 27, 2014

(51) Int. Cl. G06Q 40/08

(52) U.S. Cl. CPC G06Q 40/08

(57) ABSTRACT

A cash value feature is associated with a property and/or casualty insurance policy. Information is received about an insurance claim associated with the insurance policy. It is determined whether the insurance claim is covered by the cash value feature. The currently funded monetary value of the cash value feature is also determined The amount payable to the policy holder attributable to the cash value feature is also determined A payment of that amount to the policy holder is facilitated.

### FIELD

The present invention relates to automated handling of insurance policy-related payments and claims.

### BACKGROUND

The over-all purpose of a claim under a property/casualty insurance policy is to put the insured back in the same condition that was in effect prior to a loss event. Typical property/casualty policies do not protect the policy holder from loss due to wear and tear, gradual damage, infestations or maintenance costs; and it is often the case that the policies exclude from coverage certain sudden onset perils (e.g., perils such as flood or earth movement are excluded from many policies). Moreover, common policy provisions such as deductibles, monetary limits on amount covered, or actual cash value limits on reimbursement may also cause the claim payment to leave the policy holder exposed to some amount of out of pocket cost arising from the loss event.

The present inventors have recognized that there are opportunities to further improve financial protections for policy holders that may be associated with property/casualty insurance policies. Further, the present inventors have conceived of policy features that may encourage and facilitate property upgrades or other preventative measures that may aid in reducing the risk and/or severity of future loss events.

### SUMMARY

An apparatus, method, computer system and computer-readable data storage medium are disclosed for processing activities related to a property and/or casualty insurance policy having a cash value feature. The apparatus, method, computer system and computer-readable data storage medium may include determining if an insurance claim is covered by a cash value feature associated with a property and/or casualty insurance policy. The apparatus, method, computer system and computer-readable data storage medium may also include determining a monetary value accrued to the cash value feature. The apparatus, method, computer system and computer-readable data storage medium may further include determining an amount payable to a holder of the insurance policy in respect to the insurance claim and attributable to the cash value feature. In addition, the apparatus, method, computer system and computer-readable data storage medium may include facilitating payment of the amount payable attributable to the cash value feature.

A cash value feature associated with a property/casualty insurance policy may provide protection to the policy holder from out-of-pocket exposure that may typically be experienced in connection with loss events, and may aid the policy holder in improving insured property to resist or minimize the risk of loss events.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram of a system provided according to aspects of the present invention.

FIG. 2 is a block diagram of another system provided according to aspects of the present invention.

FIG. 3 is a block diagram representation of a computer that may form part of the system of FIG. 1.

FIG. 4 is a block diagram representation of a computer that may form part of the system of FIG. 2.

FIGS. 4A-4C are diagrams that illustrate conceptual models for associating cash value features with property/casualty policies according to embodiments of the invention.

FIGS. 5A and 5B together form a flow chart that illustrates a process that may be performed in the system of FIG. 1 according to aspects of the present invention.

FIG. 6 is a flow chart that illustrates a process that may be performed in the system of FIG. 2 according to aspects of the present invention.

FIG. 7 schematically represents potential attributes of a cash value feature that may be associated with a property/casualty insurance policy according to aspects of the present invention.

FIG. 8 is a pictorial illustration of operation of one or more of the conceptual models of FIGS. 4A-4C.

### DETAILED DESCRIPTION

The present invention provides significant technical improvements to technology utilized for conducting operations of an insurance company. The present invention is directed to more than merely a computer implementation of a routine or conventional activity previously known in the industry as it significantly advances the technical efficiency, access, functionality, and usefulness and/or accuracy of processes relating to the administration of insurance policies and handling of claims thereunder. The present invention is a specific advancement in the area of service and benefits to holders of insurance policies, in that a cash value feature may be added to property/casualty insurance properties that may mitigate exposure to out-of-pocket expenses now commonly faced by policy holders. In addition or alternatively, property improvements to reduce or mitigate future losses may be facilitated. The present invention provides improvement beyond a mere generic computer implementation as it involves performing policy administration and claim handling activities that are not currently part of the prior art in the field of insurance company operations. For example, in the present invention a cash value feature is associated with a property/casualty insurance policy. This feature may allow a policy holder to be protected from out-of-pocket exposure in the event of a loss event, and/or to “build back better” a damaged property component and/or to manage financial aspects of making preventative property improvements and/or enhancements in a manner that is not currently known in the art.

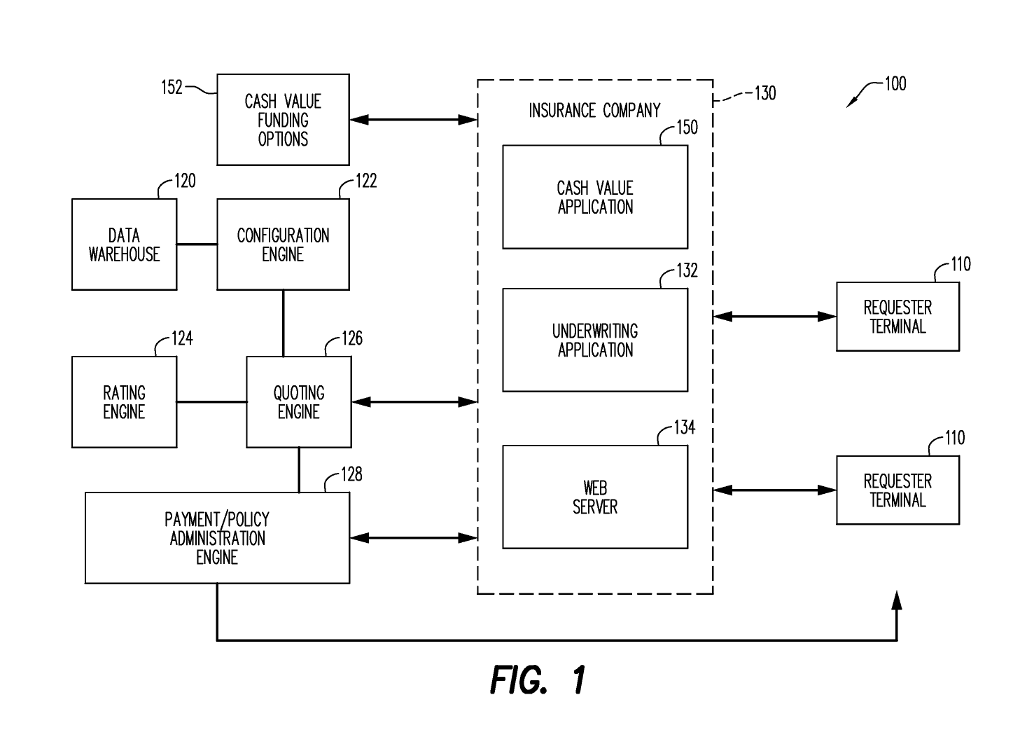

FIG. 1 is a high-level block diagram of a system 100 provided according to aspects of the present invention. The system 100 is primarily concerned with the issuance and administration of property and/or casualty insurance policies, and may therefore be referred to as an “insurance policy system.” One important feature of the insurance policy system 100 is that it may facilitate associating cash value features with property/casualty insurance policies and funding such cash value features. Although the devices of insurance policy system 100 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example embodiment shown in FIG. 1, a number of requestor terminals 110 are provided which comprise devices that may be operated by an insurance agent, a consumer, etc. seeking a recommendation of insurance coverages or information about policies including those that may have cash value features associated therewith.

Requestor terminals 110 may interact with Web pages provided by Web server 134 to request a recommendation and to provide data relating to the kinds of property or other risks to be insured and information about the customer. This data may be transmitted to the insurance computer system 130 to request a recommendation as to policy coverages and/or cash value features. Requests for recommendations and/or policy coverages may be received from individuals or entities seeking insurance coverage or submitting requests for insurance information. For example, application data submitted via a requestor terminal 110 may include information about a business, information about the insured, information about the limits and other options requested, information about property to be insured or the like, but embodiments are not limited thereto. The types of application data solicited from the customer by the insurance policy system 100 may be determined, at least in part by an underwriting application 132. The determination(s) made by the underwriting application 132 may be based, at least in part, on the type of insurance coverage(s) sought by the customer and/or by content of responses provided by the customer to earlier requests of data during the interaction with the customer. Still further, a cash value application 150 may determine information requests to be made to the customer if the customer expresses interest in having a cash value feature associated with the proposed property/casualty insurance policy

Any number of requestor terminals 110 may be employed to transmit customer and insurance request data and to present insurance coverage and other information to operators of the requestor terminals 110.

The requestor terminals 110 may be in communication with an insurance computer system 130 or other provider via a Web server 134 or other front end interface that allows remote terminals to send and receive data to the insurance company. The customer and insurance request data are received via the Web server 134 and are stored by data warehouse 120 for later action. Any number or type of data storage systems may store the data in any suitable manner according to some embodiments. Non-exhaustive examples include a relational database system, a spreadsheet, and any other data structure that is amenable to parsing and manipulating data. A data warehouse 120 may receive and store customer and application data as well as store insurance coverage package data and rules which are used in the quoting engine 126 and the configuration engine 122. At least in part, the quoting engine 126 may base quotations it generates based on rating output provided by a rating engine.

The configuration engine 122 acts to receive the customer or insurance request data and to retrieve insurance coverage package data and rules from the data warehouse 120. A configuration engine 122 may identify one or more insurance coverage packages based on the received data and on data received from Web server 134. Pursuant to some embodiments, different insurance packages are assembled for presentation to the customer based on configuration rules and information associated with each policy term. In some embodiments, the configuration engine 122 may also apply rules to identify one or more configurations of a cash value feature to be presented to the customer. The cash value feature configurations presented to the customer may include funding options retrieved from cash value funding options unit 152.

When an appropriate package (or packages) is identified by the configuration engine 122, the package may be priced using the quoting engine 126 and then presented to the customer or agent via a Web page or other user interface for viewing on a display screen of a requestor terminal 110. In addition, one or more configurations of a cash value feature may also be presented to the customer at the same time, or as part of the same process.

Once a policy quotation is accepted by the customer via a requester terminal 110, an entry for the policy may be stored in payment/policy administration engine 128. If the customer has opted for a cash value feature, an entry for that feature may also be stored in the payment/policy administration engine 128. Thus the payment/policy administration engine 128 may maintain records relating to the insurance policy and the cash value feature, and may manage billing and receipt of premiums and funding for the cash value feature.

Note that each of the engines 122, 124, 126, 128 and the insurance computer system 130 may comprise any combination of hardware and/or processor-executable instructions stored on a tangible medium. According to some embodiments, one or more of the engines 122, 124, 126 or 128 may be a component of the data warehouse 120 or the insurance computer system 130.

It should be noted that embodiments are not limited to the devices illustrated in FIG. 1. Each device may include any number of disparate hardware and/or software elements, some of which may be located remotely from one another. Functions attributed to one device may be performed by one or more other devices in some embodiments. The devices of the insurance policy system 100 may communicate with one another (and with other non-illustrated elements) over any suitable communication media and protocols that are or become known.

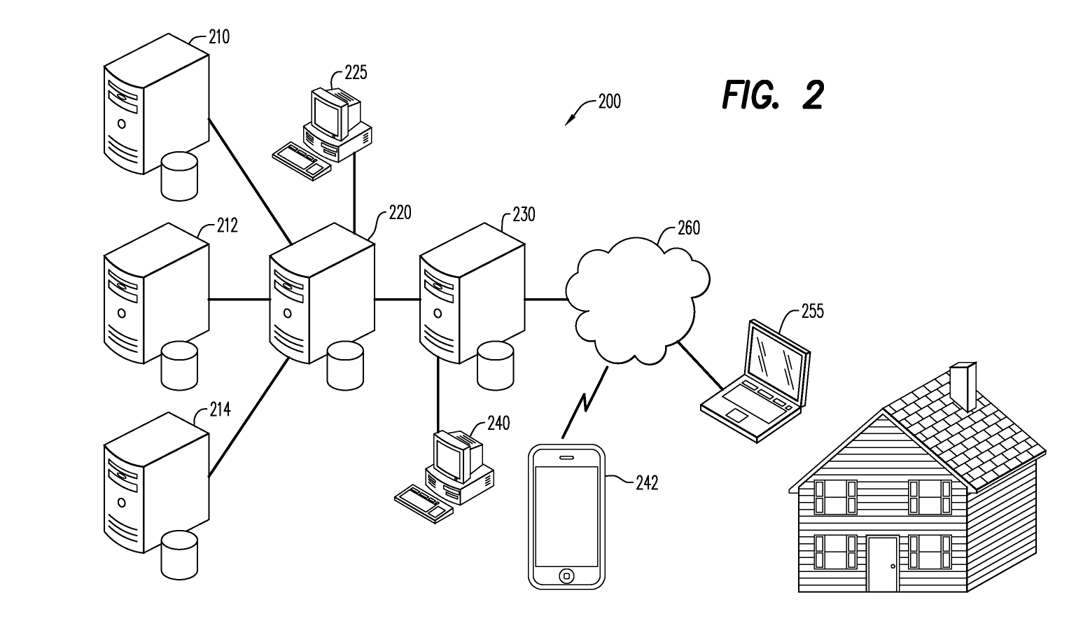

FIG. 2 illustrates an insurance claim processing system 200 provided in accordance with some embodiments. Although some devices of insurance claim processing system 200 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example of FIG. 2, policy sources 210 through 214 store policy information associated with insurance policies and associated cash value features of such policies. Policy information may include any combination of policy-related data fields that are or become known, including but not limited to policy type, policy number, insured name, deductibles, coverage limits, riders, stretch endorsement, and exceptions. The information related to the cash value features may include the manner in which the cash value features are funded, and what rights the policy holders have to claim payments under the cash value features. Each of policy sources 210 through 214 may comprise any combination of hardware and/or software, including but not limited to relational databases, application servers, and spreadsheets. One or more of policy sources 210 through 214 may comprise a policy issuing system, a data warehouse of an insurance company or any other aggregator of insurance policy information.

Pursuant to some embodiments, the policy source 210 is a source of information concerning cash value features associated with property/casualty insurance policies issued by the insurance company. Each of policy sources 210 through 214 may provide policy information to claims computer system 220 asynchronously or according to any schedule. In some embodiments, one or more of policy sources 210 through 214 provides a daily feed of policy information to claims computer system 220. The policy information of the feed may be associated with new insurance policies for which an initial premium has been paid.

A claims computer system 220 may comprise any combination of hardware and software to perform processes as described herein. According to some embodiments, when an insured party submits a claim or request for information about a policy, the claims computer system 220 receives policy information associated with an insurance policy from one of sources 210 through 214 and processes the claim or other request. In the event that an insured party submits a claim involving a policy issued pursuant to some embodiments, any of the processes described herein may be performed. In general, however, when a request is received involving a policy stored in one of the policy sources 210 through 214, the data is retrieved and returned to claims computer system 220 for processing.

As used herein and in the appended patent claims, the term “claim” or “insurance claim” includes claims for payment under cash value features associated with insurance policies, whether or not such claim for payment is occasioned by a loss event, and whether or not a claim is payable under coverage provisions of the associated insurance policy.

The claims computer system 220, as well as claims management system 230 may comprise program instructions of a database management system, database procedures and/or database applications to process the data stored at those systems or retrieved by those systems. One or more administrator terminals 225 may be operated to edit this data and to otherwise provide commands to system 220. For example, an administrator terminal 225 may be operated to update a data structure including information associated with a claim or the like. A terminal 225 may comprise any suitable device, including but not limited to a desktop computer.

The claim management system 230 may receive policy records and associated claim handling identifiers from claims computer system 220. The claim management system 230 may receive a report of a claim associated with an insurance policy (and/or associated with a cash value feature associated with an insurance policy) and determine the claim handling identifier of the record associated with the insurance policy. A customer service representative may use the claim handling identifier to assign the claim to the appropriate claim-handling organization. In this regard, customer service representatives may operate terminals 240 and 242 to access the records of claim management system 230. All terminals described herein may comprise any suitable devices for requesting and displaying user interfaces, including but not limited to desktop computers, cellular telephones, personal digital assistants, and laptops.

According to some examples, an insured individual suffers a loss (e.g., damage to a building) which involves a loss event (e.g., a fire or windstorm) and submits a claim to the claims management system 230 over a network interface (for example, the claim may be submitted using a phone (not shown) or a computer terminal 255). In addition or alternatively, a situation may occur (not necessarily involving a loss event) in which the insured individual is entitled to claim a payment under the provisions of a cash value feature associated with a property/casualty insurance policy.

Whether the claim is submitted via a phone (not shown) or a computer terminal 255, the claim request is routed to a telephone 242 associated with a customer service representative. For example, the insured individual (who suffered the loss event and/or wishes to claim payment under the cash value feature) may operate a telephone to call a claim-reporting telephone number provided by an insurance company. The call is passed through a network 260 (e.g., the PSTN, a cellular network, and/or an IP network) and terminates at telephone 242 of a customer service representative. Embodiments may also or alternatively provide claim reporting via one or more other communication modes, such as facsimile, electronic mail, or World Wide Web/interaction with an insurance company claims service web page.

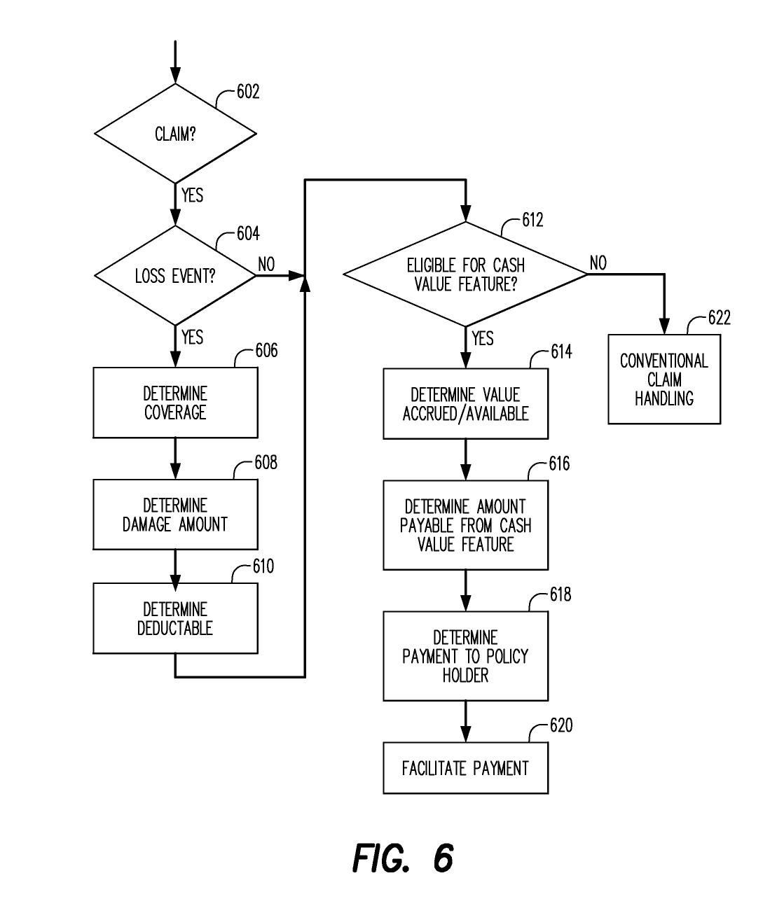

The customer service representative receives an identifier of the insured's policy (e.g., policy number, social security number, etc.) and operates a client application executed by terminal 240 to retrieve a record of claim management system 230 associated with the policy and any associated cash value feature. The customer service representative determines a claim handling identifier of the record and assigns the claim based thereon. Depending on the nature of the claim handling identifier, assignment of the claim may include providing a telephone number of a third-party administrator to the insured or transferring the telephone call to a claim-handling organization of the insurance company. If the claim is related to a cash value feature, a process is then performed by the claim management system 230 to determine what if any payment should be made to the insured in connection with the cash value feature. Details of such a process will be described below in connection with FIG. 6.

The insurance claim processing system 200 of FIG. 2 may provide other administration and maintenance features associated with policies and/or cash value features issued pursuant to the present invention. For example, the claims computer system 220 may operate to receive and process policy change or update requests and may generate an interface or display screens to allow faster and easier policy service and/or updating of cash value features. Agents and insureds may interact with the claims computer system 220 to manage customers' policy changes in real-time by performing actions such as: (i) add, replace, delete or change insured locations and coverages; (ii) quote “what if” scenarios and save them for later, (iii) provide an immediate or substantially real time confirmation on a wide variety of policy changes, (iv) view a billing breakdown, print ID cards and forms, etc.

The claims computer system 220 may also include a vendor interface to control communications between third party vendor systems and claim data associated with claims processed using claims computer system 220. For example, a vendor interface may facilitate communication to secure vendor services for a customer who has initiated a claim. As a specific illustrative example, for a customer who has initiated a claim for damage to an insured building, a list of preferred contractors in the customer's area may be automatically generated (and similarly, a notification may be transmitted to one or more contractors of the customer's need for repairs).

It should be noted that embodiments are not limited to the devices illustrated in FIG. 2. Each device may include any number of disparate hardware and/or software elements, some of which may be located remotely from one another. Functions attributed to one device may be performed by one or more other devices in some embodiments. The devices of insurance claim processing system 200 may communicate with one another (and with other non-illustrated elements) over any suitable communication media and protocols that are or become known.

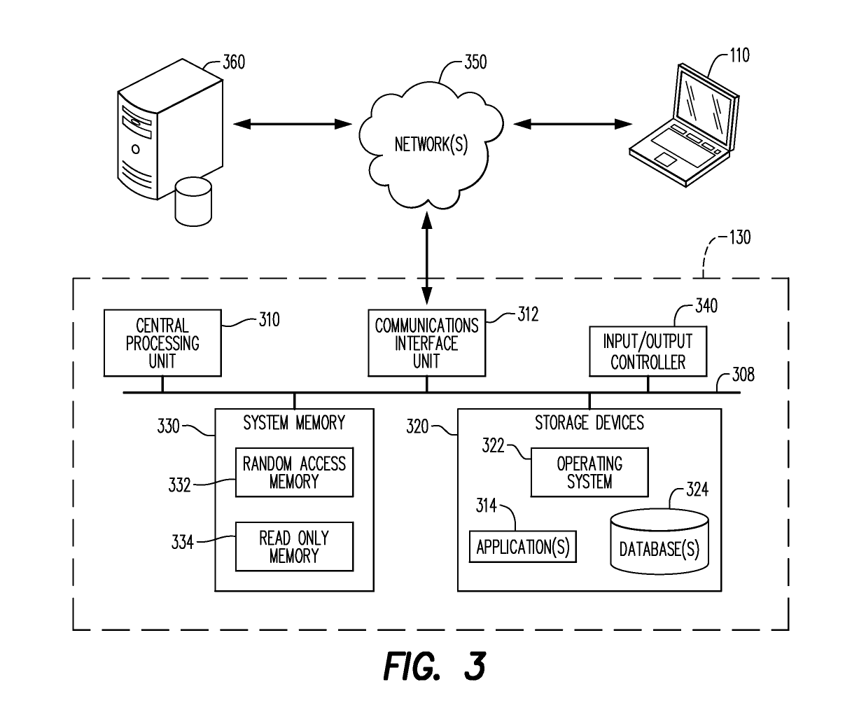

FIG. 3 is a block diagram representation of an example embodiment of the insurance computer system 130 (FIG. 1), together with some other components of the insurance policy system 100. Although the insurance computer system 130 may in some embodiments be implemented by suitably programmed general purpose data processing equipment, nevertheless in other embodiments the insurance computer system 130 may be constituted by special purpose hardware designed and configured to provide functionality as described herein. It is well within the capabilities of those who are skilled in the art to implement the special purpose equipment referred to herein based on the present functional description of the insurance policy system 100.

In the example insurance computer system 130 depicted in FIG. 2, a central processing unit or processor 310 executes instructions contained in programs, including for example application software programs 314, stored in storage devices 320. The application software programs 314 may provide functionality as described herein to implement an embodiment of the insurance computer system 130 and/or to provide functionality of the insurance computer system 130 as described herein. Processor 310 may provide the central processing unit (CPU) functions of a computing device on one or more integrated circuits.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 320 may include suitable media, such as optical or magnetic disks, fixed disks with magnetic storage (hard drives), tapes accessed by tape drives, and other storage media. Processor 310 communicates, such as through bus 308 and/or other data channels, with communications interface unit 312, storage devices 320, system memory 330, and input/output controller 340. System memory 330 may further include non-transitory computer-readable media such as a random access memory 332 and a read only memory 334. Random access memory 332 may store instructions in the form of computer code provided by one or more application(s) 314 to implement teachings of the present invention. The insurance computer system 130 further includes an input/output controller 340 that may communicate with processor 310 to receive data from user inputs such as pointing devices, touch screens, and audio inputs, and may provide data to outputs, such as data to video drivers for formatting on displays, and data to audio devices.

Continuing to refer to FIG. 3, storage devices 320 are configured to exchange data with processor 310, and may store programs containing processor-executable instructions, and values of variables for use by such programs. Processor 310 is configured to access data from storage devices 320, which may include connecting to storage devices 320 to obtain or read data from the storage devices, or place or store data into the storage devices. Storage devices 320 may include local and network accessible mass storage devices. Storage devices 320 may include media for storing operating system 322 and mass storage devices such as storage 324 for storing one or more databases, including one or more databases relating to issued insurance policies and policy features.

Communications interface unit 312 may communicate via one or more network(s) 350 with other devices, such as requestor terminals 110 (of which one is depicted in FIG. 3) and/or other computing resources, represented at 360 in FIG. 3. The network(s) 350 may at least in part be constituted by one or more mobile telecommunication networks, an insurance company intranet or other internal network and/or the internet.

Continuing to refer to FIG. 3, the insurance computer system 130 may be constituted by special purpose hardware, general purpose computer hardware or alternatively may be configured in a distributed architecture of general purpose data processing equipment, wherein databases and processors are housed in separate units or locations. Some such servers may perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP. The network(s) 350 may be or include wired or wireless local area networks and wide area networks, and may be implemented at least in part via communications between networks, including over the Internet.

One or more public cloud, private cloud, hybrid cloud and cloud-like networks may also be implemented, for example, to handle and conduct processing of one or more tasks, transactions, operations or processes as described herein as aspects of the present invention. Cloud based computing may be used herein to handle any one or more of the application, storage and connectivity requirements of the insurance computer system 130 and aspects of the present invention. For example, one or more private clouds may be implemented to handle web hosting, and data processing and storage in accordance with aspects of the present invention. Furthermore, any suitable data and communication protocols may be employed to accomplish the teachings of the present invention.

With reference still to FIG. 3, communications interface 312 may be used for receiving and/or transmitting data relating to applications for and quotations for insurance policies and related policy features. Processor 310 may execute program instructions, such as program instructions provided by application(s) 314 to receive (via the communications interface 312) and to store (in database storage 324) the data relating to requests for and issuance of insurance policies and policy features.

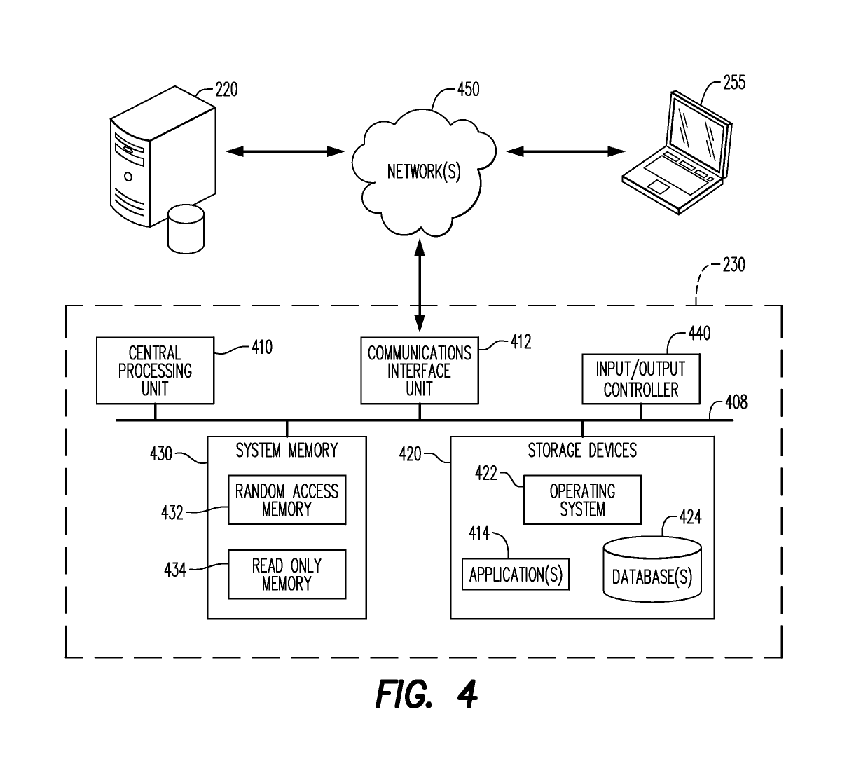

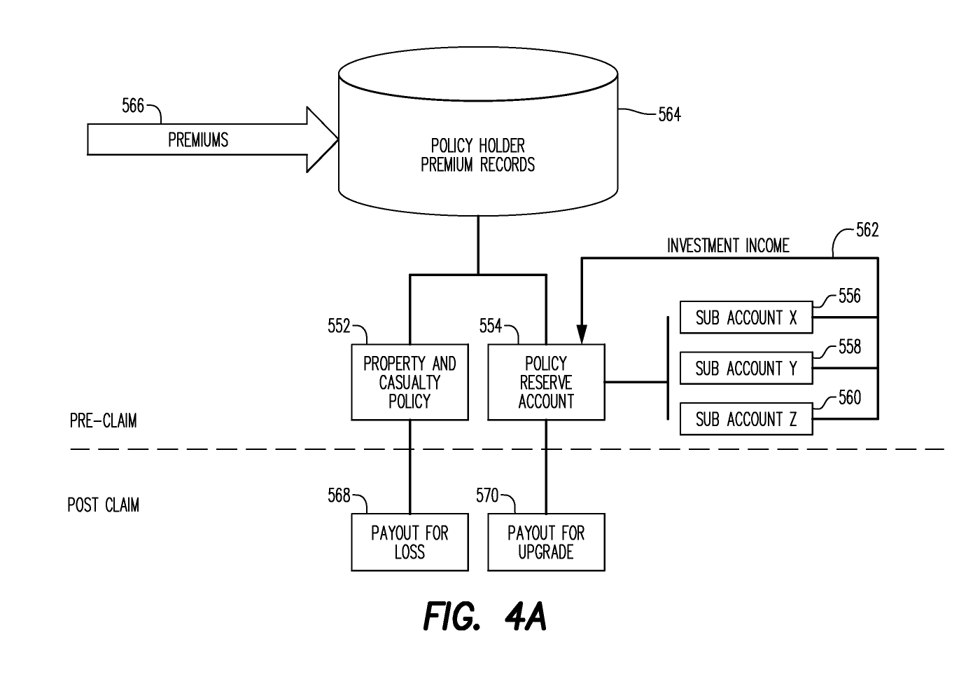

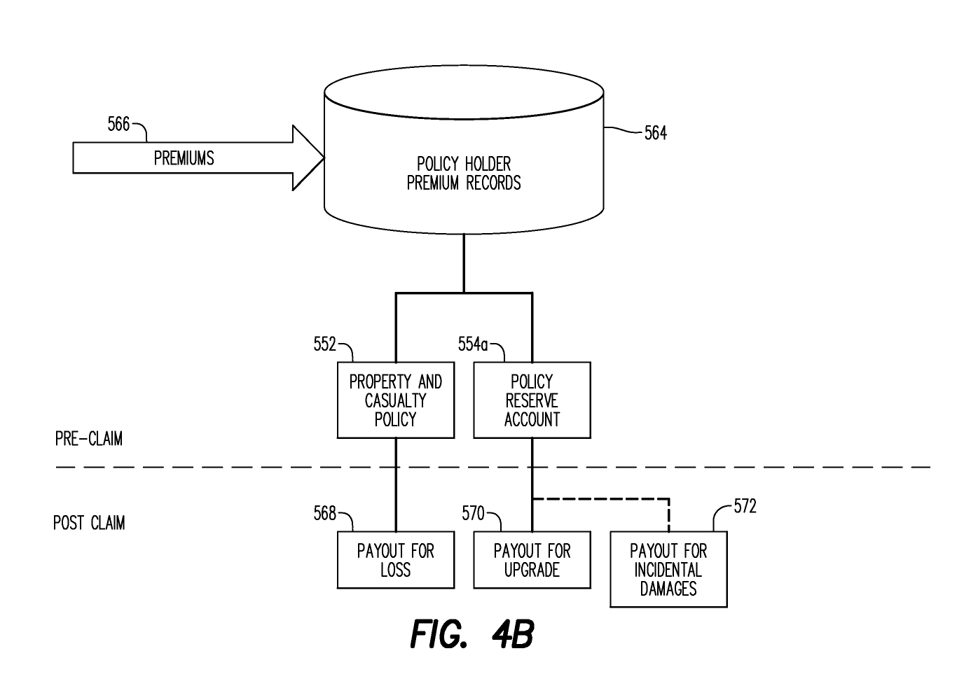

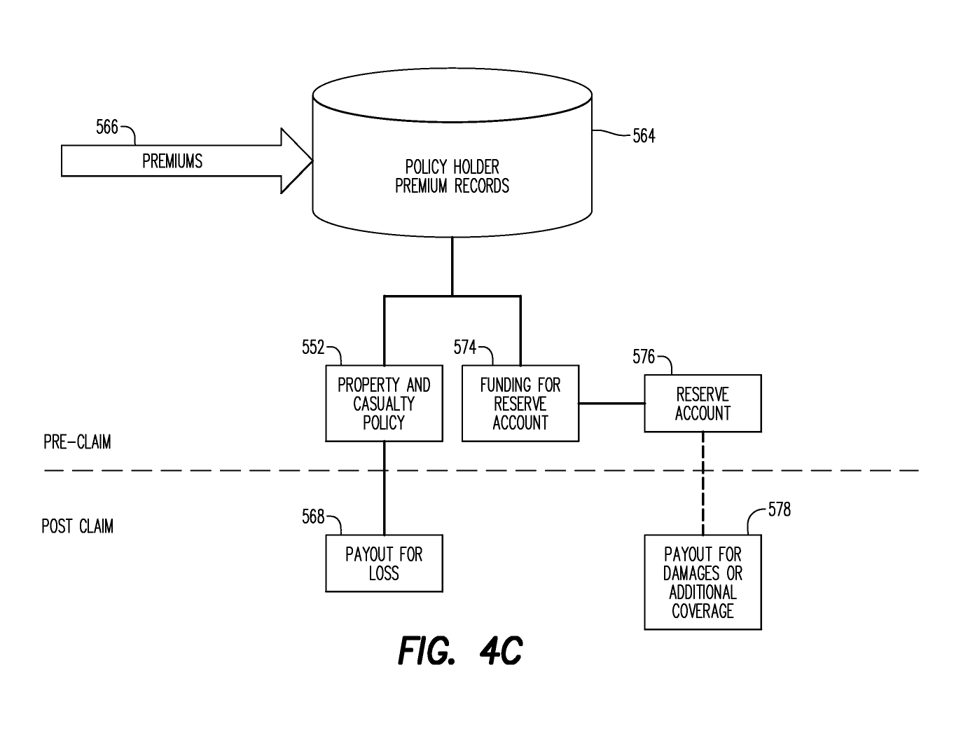

FIG. 4 is a block diagram representation of an example embodiment of the claims management system 230 (FIG. 2), together with some other components of the insurance claim processing system 200. The hardware architecture of the claims management system 230 may be the same as or similar to the hardware architecture described above in connection with FIG. 3. Thus the description of the features shown in FIG. 3 is applicable to similarly named features shown in FIG. 4.

The claims management system 230 includes a central processing unit 410, a communications interface unit 412, an input/output controller 440, and a bus 408. The claims management system 230 further includes storage devices 420 that may stores application programs 414, an operating system 422, and databases 424, including databases relating to claims filed by insurance policy holders. Still further, the claims management system 230 includes system memory 430, which may comprise random access memory 432 and read only memory 434.

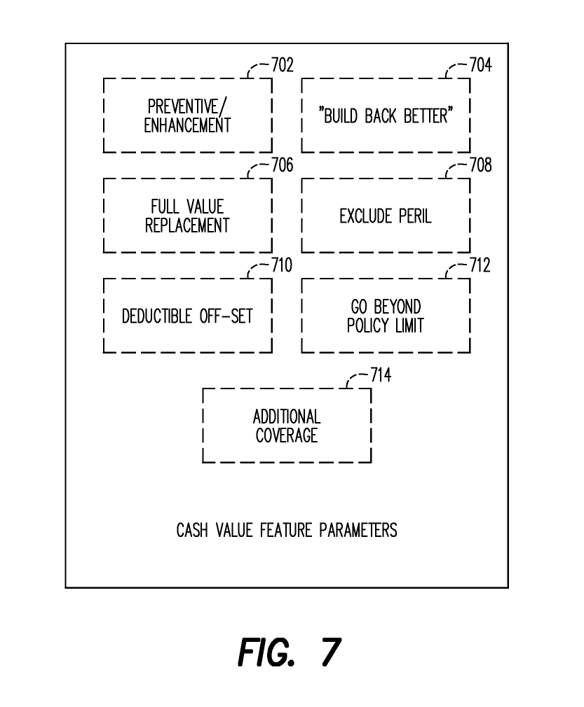

Like the processor 310 discussed in connection with FIG. 3, the processor 410 shown in FIG. 4 may be programmed with program instructions to provide functionality as described herein. For example, the processor 410 may be programmed to handle claims relating to property/casualty insurance policies and associated cash value features as described below, particularly with reference to FIGS. 6 and 7.

Via the communications interface unit 412 and network(s) 450, the claims management system 230 may communicate with policy holder computer terminals 255 (of which one is shown in FIG. 4), and with other computer resources, such as claims computer system 220.

FIGS. 4A-4C are diagrams that illustrate conceptual models for associating cash value features with property/casualty policies according to embodiments of the invention.

In the conceptual model illustrated in FIG. 4A, a cash value feature is associated with a property/casualty insurance policy 552 via a reserve investment account 554 formed of investment sub-accounts 556, 558, 560. As indicated at 562, income from the sub-accounts accrues to the reserve account 554. Reference numeral 564 represents a database of policy premium payment records, reflecting payments 566 that cover premiums and funding of the reserve account 554.

In the event of a claim, a payout 568 for a covered loss is governed by the insurance policy 552, while an additional payout 570 is funded from the reserve account 554, to support a property upgrade or “build back better” cash value feature, as described in more detail below.

In the conceptual model illustrated in FIG. 4B, a reserve account 554a again is associated with insurance policy 552. The reserve account 554a may not have any investment features or subaccounts, though in some embodiments it may accrue a fixed or variable interest rate return.

As before, the premium records database 564 reflects payments 566, and a payout 568 related to a claim is governed by the insurance policy 552. Also in this model, property upgrade/“build back better” payout 570 is funded from the reserve account 554a. In addition or alternatively, the reserve account 554a may fund a payout 572 for incidental damages or expenses not covered by the insurance policy 568.

In the conceptual model of FIG. 4C, the insurance policy 552 is supplemented by additional funding 574 to support a reserve account 576. The reserve account may be drawn on for payout(s) 578. The payout(s) 578 may cover damages not reimbursed from the insurance policy and/or may be applied to obtain one or more additional insurance coverages to supplement the insurance policy 552. As before, the premium records database 564 reflects payments 566, and a payout 568 related to a claim is governed by the insurance policy 552.

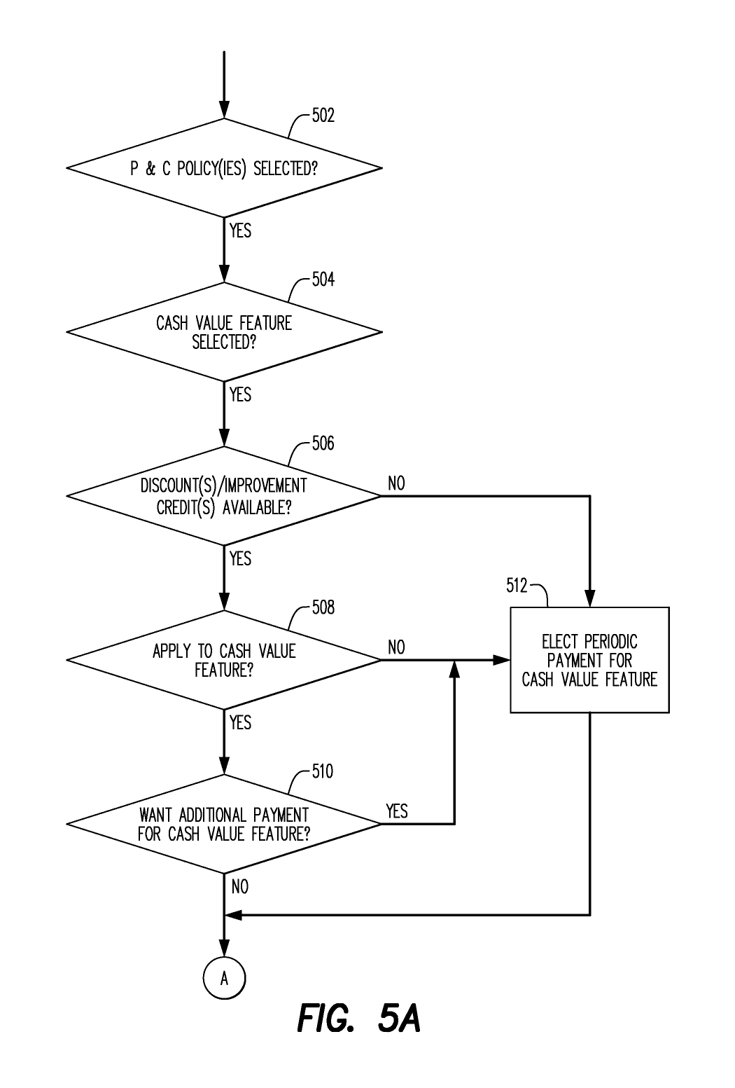

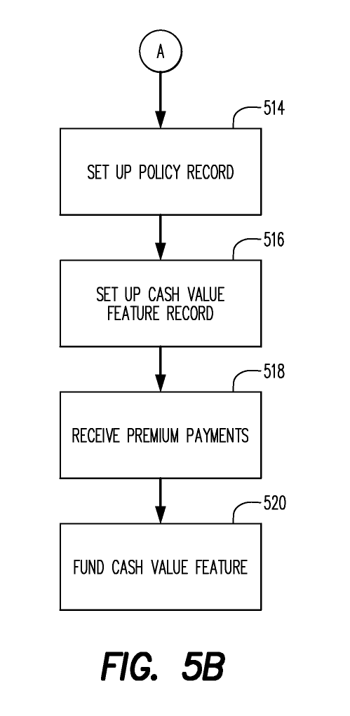

FIGS. 5A and 5B together form a flow chart that illustrates a process that may be performed in the insurance policy system 100 of FIG. 1 according to aspects of the present invention.

The process of FIGS. 5A/5B may be triggered by an inquiry from a requester terminal 110 to the insurance computer system 130. In a substantially conventional manner, the user of the requester terminal 110 may explore potential coverage options. At decision block 502 in FIG. 5A, the insurance computer system 130 may determine whether the user has elected to apply for a property/casualty insurance policy (e.g., a homeowner's insurance policy, a renter's insurance policy, an automobile insurance policy). If so, then decision block 504 may follow block 502. At decision block 504, the insurance computer system 130 may determine whether the user has elected a cash value feature associated with the property/casualty insurance policy (this assumes that such a feature was available). If the insurance computer system 130 makes a positive determination at 504 (i.e., if the user has elected a cash value feature), then decision block 506 may follow decision block 504. At decision block 506, the insurance computer system 130 may determine whether the user was entitled to have one or more discounts applied to the premiums for the property/casualty insurance policy. (For example, and assuming that the policy in question is a homeowner's policy, the user may be entitled to a discount on the premiums on that policy if he/she also holds an automobile insurance policy from the same insurance company.)

Moreover, it may also or alternatively be determined at decision block 506 whether an “improvement credit” is available to potentially fund the cash value feature. In some embodiments, an improvement credit may come about if the user has elected to make on improvement on the insured policy such that the risk and/or severity of future risks is reduced. In such a case, the insurance company may grant a credit or credits to the policy holder over a period of time to reflect a portion of the reduction in risk borne by the insurance company. As will be seen, the user may have the option to fund or partially fund the cash value feature from the improvement credit. Alternatively, the user may opt to apply the credit to reduce the premium for insuring the property. In some embodiments, the improvement credit may fund the cash value feature for a period of time, and then the balance of the credit may be applied to the premiums over a subsequent period of time.

If the insurance computer system 130 makes a positive determination at decision block 506, then decision block 508 may follow. At decision block 508, the insurance computer system 130 may inquire of the user whether the user wishes to fund (or at least partially fund) the cash value feature by applying the premium discount(s) and/or improvement credit(s) for which he/she is eligible. If so, then decision block 510 may follow decision block 508. At decision block 510, the insurance computer system 130 may inquire of the user as to whether he/she wishes to make an additional periodic payment to fund the cash value feature in addition to the funding available by applying the premium discount and/or improvement credit. If the user indicates yes, then the process of FIG. 5A may advance from decision block 510 to block 512. At block 512, the user may agree to periodic payments that he/she will pay to the insurance company to provide funding for the cash value feature.

Considering again decision block 506, if the insurance computer system 130 determines at that decision block 506 that no premium discount/improvement credit is available for the selected insurance coverage, then block 512 may follow decision block 506. Similarly, and considering again decision block 508, if the user determines not to apply any available premium discount to funding the cash value feature, then block 512 may follow decision block 508. In other words, if no premium discount/credit is available, or if the user does not wish to apply an available discount/credit to funding the cash value feature, or if the user wishes to supplement an available discount/credit that he/she elected to use to fund the cash value feature—in all of these cases—the user may elect to make periodic payments to the insurance company to provide funding for the cash value feature, as represented by block 512 in FIG. 5A.

Block 514 (FIG. 5B) may follow block 512 (FIG. 5A) in the process flow of FIGS. 5A/5B. Or by an alternative path, block 514 in FIG. 5B may be reached after a negative determination at decision block 510 in FIG. 5A.

Referring then to FIG. 5B, at block 514, the insurance computer system 130 may set up an insurance policy record in the pertinent database for the insurance coverage selected by the user/customer/policy holder, according to the determination made at decision block 502 (FIG. 5A).

Referring again to FIG. 5B, block 516 may follow block 514. At block 516, the insurance computer system 130 may set up an appropriate record for the cash value feature that the insurance computer system 130 determined had been selected by the customer at decision block 504 (FIG. 5A). This record may be established in the pertinent database.

Referring again to FIG. 5B, block 518 may follow block 516. At block 518, the insurance computer system 130 may receive, or record receipt of, the applicable premiums for the insurance coverage selected by the customer.

Block 520 may follow block 518 in the process flow of FIG. 5B. At block 520, the insurance computer system 130 may fund the cash value feature selected by the customer according to the method selected through the process flow at blocks 506 through 512. That is, in some embodiments, the cash value feature may be funded by either or both of periodic payments from the customer/policy holder and/or by applying to the cash value feature premium discounts for which the customer is eligible.

In some embodiments, additional or alternative funding options may be available for a cash value feature associated with a property/casualty insurance policy. For example, in a case where the customer submits a claim that is subject to a so-called “vanishing deductible” feature, the customer may elect that the deductible amount, to the extent it is forgiven as a “vanishing deductible” may be applied to a currently established or previously established cash value feature.

According to an alternative model, the insurance company may advance funds for property upgrades that would reduce exposure to covered loss, and the advanced amount may be amortized by a portion of a premium reduction attributable to the reduced risk of loss.

In some embodiments, the cash value feature may include one or more mechanisms by which funds attributed to that feature may earn income or otherwise grow so as to increase the total amount of value accrued to the cash value feature. For example, in some embodiments, the cash value accrued may be invested in a fund that is managed to achieve one or more investment goals. In some embodiments the fund may be, or may be similar to, a mutual fund. In addition or alternatively, the cash value accrued to the cash value feature may earn a fixed or variable interest rate. Thus value accrued to the cash value feature may grow above and beyond amounts paid in by the policy holder or otherwise applied to fund the cash value feature.

FIG. 6 is a flow chart that illustrates a process that may be performed in the insurance claim processing system 200 of FIG. 2 according to aspects of the present invention. In particular, the process flow of FIG. 6 may reflect actions taken by or with the support of the claims management system 230 of FIGS. 2 and 4.

At decision block 602 in FIG. 6, the claims management system 230 may determine whether a claim has been received in relation to a property/casualty insurance policy issued by the insurance company. If so, then a decision block 604 may follow decision block 602.

At decision block 604, the claims management system 230 may determine whether the claim is the result of a loss event. (As will be understood from subsequent discussion, when a cash value feature is associated with a property/casualty insurance policy in accordance with teachings of this disclosure, the policy holder may submit a claim for payment under the cash value feature even in the absence of a loss event.)

If the claims management system 230 makes a positive determination at decision block 604 (i.e., if the claim arose from a loss event), then block 606 may follow block 604. At block 606, the claims management system 230 (or a claim manager/adjuster working in conjunction with the claims management system 230) may determine whether the loss event is one that is covered under the terms of the insurance policy.

Assuming that coverage is present, an adjuster/claim manager may (as indicated at block 608) determine the amount of loss—i.e., the amount of damage suffered by the policy holder as a result of the loss event. The amount of loss may also sometimes be referred to as the “incurred damage amount”.

At block 610, the claims management system 230 and/or an insurance company employee/claim manager working in conjunction with the claims management system 230 may determine whether the terms of the insurance policy call for a deductible amount that is applicable to the current claim.

Following one or more of blocks 606 through 610 is a decision block 612. At decision block 612, the claims management system 230 and/or a claim manager working with the claims management system 230 may determine whether the claim submitted by the policy holder is eligible for payment under a cash value feature associated with the insurance policy. Assuming that this is the case, then block 614 may follow decision block 612.

At block 614, the claims management system 230 may determine the amount of cash value that has accrued to the cash value feature and is available for payment in connection with the claim.

Block 616 may follow block 614. At block 616, the claims management system 230 or a claim manager working with the claims management system 230 may determine an amount that is payable to the policy holder pursuant to the cash value feature. This determination may be based on one or more attributes of the cash value feature. FIG. 7 schematically represents potential attributes of a cash value feature that may be associated with a property/casualty insurance policy according to aspects of the present invention. One or more of these attributes may be relevant to the determination made at block 616 in FIG. 6.

Referring now to FIG. 7, block 702 represents an attribute of a cash value feature such that a claim is submittable for an expenditure for work on a property to potentially prevent a loss event and/or to enhance the property so that the severity of a loss event would likely be reduced. An example of such a preventive/enhancement expenditure would be to replace/upgrade a conventional roof using materials and/or a design that is constructed to resist damage from hailstorms and/or windstorms. Similarly, expenditures to bring a roof or other part of a building up to subsequently enacted code requirements may fall in this category, if the code requirements are such as to reduce susceptibility to weather perils.

Block 704 in FIG. 7 represents an attribute of the cash value feature such that payment may be made under this feature after a loss event to augment an amount payable under the other policy provisions such that a damaged portion of a building can be replaced in a manner that is more resistant to loss than the portion was prior to the loss incident. This may be referred to as a “build back better” attribute of the cash value feature.

Block 706 in FIG. 7 represents a full value replacement attribute of the cash value feature. This attribute may be useful to supplement insurance coverages that, in case of a loss, only pay for the actual cash value of the loss incurred. With the full value replacement attribute, the policy holder may claim payment from the cash value feature to cover the difference between the full cost of the repair and the amount payable under the applicable policy coverage provision.

Block 708 in FIG. 7 represents an excluded peril attribute of the cash value feature. According to this attribute, the policy holder may claim payment from the cash value feature to cover a loss that was caused by a peril (e.g., flood or earthquake) that is excluded from coverage under the associated insurance policy. This attribute may also allow claims against the cash value feature for other causes of loss or property-related expenses, such as wear and tear, equipment breakdown or failure, termite damage, etc.

Block 710 in FIG. 7 represents a deductible off-set attribute of the cash value feature. With this attribute, the policy holder may claim payment from the cash value feature to cover a deductible amount that according to the insurance policy reduces the payment to be made for the loss under the policy coverage provisions.

Block 712 in FIG. 7 represents a “beyond policy limit” attribute of the cash value feature. According to this attribute, the policy holder may claim payment from the cash value feature for loss and/or cost of repair that exceeds a dollar limit set forth in the insurance policy as to an amount payable under a certain coverage and/or for a certain category of loss. For example, if the policy limits coverage for damage or loss to personal property to $10,000 but the loss in personal property was $12,000, the policy holder may claim the additional $2,000 from the cash value feature, assuming that sufficient cash value had accrued under the cash value feature.

Block 714 represents an “additional coverage” attribute of the cash value feature. With this attribute the policy holder may apply funds accrued to the cash value feature for the purpose of obtaining one or more additional insurance coverages in addition to insurance coverage that is already in place.

In some embodiments, the cash value feature may have some or all of the attributes indicated in FIG. 7. In some embodiments, the cash value feature may have one or more other attributes not illustrated in FIG. 7 in addition to or instead of the attributes illustrated in FIG. 7.

In some embodiments, the amount that is determined to be payable from the cash value feature may be limited to the amount of cash value currently associated with that feature.

Referring again to FIG. 6, block 618 may follow block 616. At block 618, the claims management system 230 and/or a claim manager working with the claims management system 230 may determine a total payment that is to be paid to the policy holder with respect to the claim. The total payment may be the sum of an amount or amounts payable pursuant to coverage provisions of the insurance policy (e.g., taking any applicable deductible(s) or policy limits into account) plus an amount or amounts payable in connection with the cash value feature.

At block 620, the claims management system 230 may facilitate payment to the policy holder of the total amount payable as determined at block 618. The processing of block 620 may include, for example, issuing and mailing a check to the policy holder or executing a cash transfer directly to the policy holder's bank account. In some embodiments, the amount paid to the policy holder with respect to the cash value feature is applied to reduce the accrued value associated with that feature.

In some embodiments, when a claim is submitted in connection with a loss event, and the insurance policy in question has an associated cash value feature, the claims management system 230 may automatically determine whether or not there is a potential payout available under the cash value feature, even if the policy holder has not referred to the cash value feature in submitting the claim. The claims management system 230 may contact the policy holder or otherwise inform the policy holder that such a payout is available. The claims management system 230 may indicate to the policy holder what payout options are available under the cash value feature, and may ask the policy holder to indicate whether or not he/she wishes to receive payment under the cash value feature. If the policy holder indicates that he/she desires such a payment, the claims management system 230 may present the available payout options under the cash value feature (e.g., deductible off-set, payment beyond policy limit, “build back better”, etc.), and the claims management system 230 may indicate the respective amounts available under those options. The claims management system 230 may then ask the policy holder to indicate which, if any, of those options the policy holder wishes to select, and in what amounts.

Referring again to decision block 612, if it is determined at that decision block that the current claim is not eligible for access to the cash value feature, then block 622 may follow decision block 612. At block 622, the claim may be processed in a conventional manner, without application of any cash value feature associated with the insurance policy.

Referring again to decision block 604, if it is determined at that decision block that the current claim is not a result of a loss event, then the process flow of FIG. 6 may advance from decision block 604 to decision block 612. That is, blocks 606 through 610 may be by-passed in such a case. Moreover, in such a case, the processing of blocks 614 through 620 may reflect the fact that no loss event has occurred, and attributes of the cash value feature related to loss events and supplementing insurance coverage for loss events may not be applied during performance of the process flow. According to one example situation, the claim in such a case may be under the preventive measure/property enhancement attribute discussed above in connection with block 702 of FIG. 7.

By associating a cash value feature with a property/casualty insurance policy as described herein, the policy holder may have an opportunity to have funding available for property enhancement and risk mitigation initiatives. In addition or alternatively, the value residing in the cash value feature may supplement conventional property/casualty insurance and may help buffer the policy holder from the type of out-of-pocket costs frequently faced in the wake of a loss event even when proper conventional insurance coverage has been maintained. Still further, the cash value feature may be a sound way of accumulating and building value, through both policy holder payments and/or asset growth, to help the policy holder achieve the goals of responsible property ownership. It is also contemplated that under some legal/regulatory regimes, the cash value feature may be a tax-advantaged vehicle for building value and achieving the policy holder's goals.

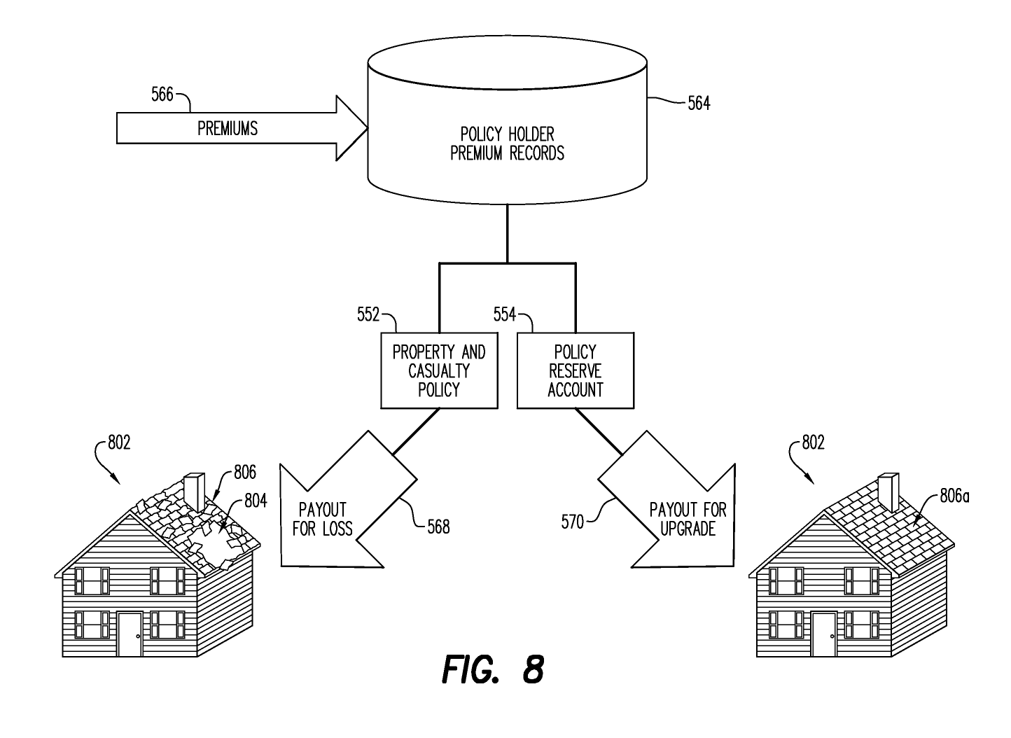

FIG. 8 is a pictorial illustration of operation of one or more of the conceptual models of FIGS. 4A-4C. For example, as per FIGS. 4A and/or 4B, premium payments 566 are recorded in policy premium payment record 564, and serve to fund insurance policy 552 and reserve account 554.

For the example illustrated in FIG. 8, it is assumed that an insured house 802 has suffered damage 804 to its roof 806, due to, e.g., a hailstorm or windstorm. The payout 568 from the insurance policy 552 is calculated according to the monetary amount of the damage to the roof. The reserve account 554 provides a further payout 570 to provide the necessary additional funding for an overall upgrade to the roof—illustrated in a repaired and upgraded condition at 806a.

In some embodiments, the cash value feature associated with a homeowner's insurance policy may be implemented in connection with the mortgage escrow for the insured property. For example, the cash value feature in such a case may be funded from regular transfers from the escrow account held by the mortgagee or mortgage servicing company. As is conventional, the premiums for the homeowner's insurance coverage may also be paid automatically from the mortgage escrow account. In some embodiments, the cash accrued to the cash value feature may be maintained as a separate interest-bearing account for the homeowner/policy holder at the same bank that holds the escrow account.

Embodiments of the present invention have been described above primarily in association with examples related to insurance of improvements to real property. However, the invention is not so limited. For example, the present invention has applicability to automobile insurance policies. For example, a cash value feature associated with an automobile insurance policy may be used to pay for an upgrade to vehicle safety equipment and/or for new (and potentially safer) tires and/or for a repair after an accident that enhances the safety of the vehicle and/or to off-set a deductible amount that is applicable to vehicle property damage coverage.

The process descriptions and flow charts contained herein should not be considered to imply a fixed order for performing process steps. Rather, process steps may be performed in any order that is practicable.

As used herein and in the appended claims, the term “computer” refers to a single computer or to two or more computers in communication with each other and/or operated by a single entity or by two or more entities that are partly or entirely under common ownership and/or control.

As used herein and in the appended claims, the term “processor” refers to one processor or two or more processors that are in communication with each other.

As used herein and in the appended claims, the term “memory” refers to one, two or more memory and/or data storage devices.

As used herein and in the appended claims, an “entity” refers to a single company or two or more companies that are partly or entirely under common ownership and/or control.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. An insurance claims processing system associated with a property and/or casualty insurance policy having a cash value feature, comprising:
a communication device to receive information about an insurance claim associated with the insurance policy, said insurance policy including one or more provisions relating to one or more of: (a) at least one policy coverage; (b) at least one deductible amount; (c) at least one policy limit; and (d) at least one coverage exclusion;
a computer processor for executing program instructions; and
a memory, coupled to the computer processor, for storing program instructions for execution by the computer processor to perform functions as follows:
determining if the insurance claim is covered by the cash value feature, including determining that at least part of the insurance claim is not payable pursuant to one or more of said provisions relating to policy coverage, deductible amount, policy limit and/or coverage exclusion;
determining a monetary value accrued to the cash value feature;
determining an amount payable to a holder of the insurance policy in respect to the insurance claim and attributable to the cash value feature; and
facilitating payment of said amount payable attributable to the cash value feature.

2. The system of claim 1, wherein the computer processor executes program instructions to determine, based on information associated with the insurance claim, an incurred damage amount associated with a loss event.

3. The system of claim 2, wherein the computer processor executes program instructions to facilitate payment of the incurred damage amount associated with the loss event, with the amount payable attributable to the cash value feature off-setting a deductible amount defined in the insurance policy.

4. The system of claim 2, wherein:
the loss event resulted in damage to a component of a building covered by the insurance policy; and
the computer processor executes program instructions to facilitate payment of a further amount in addition to said amount payable attributable to the cash value feature, said further amount equal to said determined incurred damage amount less a deductible amount defined in the insurance policy, the amount payable attributable to the cash value feature calculated to permit an enhanced repair to the damaged component of the building.

5. The system of claim 2, wherein said loss event resulted from a peril excluded from coverage by the insurance policy, and said payment of said amount payable attributable to the cash value feature at least partly covers the incurred damage amount.

6. The system of claim 2, wherein said payment of said amount payable attributable to the cash value feature at least partly covers an excess of the incurred damage amount over an applicable coverage limit defined in the insurance policy.

7. The system of claim 1, wherein said insurance claim is placed under said cash value feature in respect to preventive maintenance or loss-resistance enhancement for an item of property covered by the insurance policy.

8. The system of claim 7, wherein said item of property is a building or a motor vehicle.

9. A method for processing an insurance claim associated with an insurance policy, the method comprising:
receiving information about the insurance claim, the insurance policy having an associated cash value feature, the insurance policy including one or more provisions relating to one or more of: (a) at least one policy coverage; (b) at least one deductible amount; (c) at least one policy limit; and (d) at least one coverage exclusion;
determining if the insurance claim is covered by the cash value feature, including determining that at least part of the insurance claim is not payable pursuant to one or more of said provisions relating to policy coverage, deductible amount, policy limit and/or coverage exclusion;
determining a monetary value accrued to the cash value feature;
determining an amount payable to a holder of the insurance policy in respect to the insurance claim and attributable to the cash value feature; and
facilitating payment of said amount payable attributable to the cash value feature.

10. The method of claim 9, further comprising:
determining, based on information associated with the insurance claim, an incurred damage amount associated with a loss event.

11. The method of claim 10, further comprising:
facilitating payment of the incurred damage amount associated with the loss event, with the amount payable attributable to the cash value feature off-setting a deductible amount defined in the insurance policy.

12. The method of claim 10, wherein:
the loss event resulted in damage to a component of a building covered by the insurance policy; and
the method further comprising:
facilitating payment of a further amount in addition to said amount payable attributable to the cash value feature, said further amount equal to said determined incurred damage amount less a deductible amount defined in the insurance policy, the amount payable attributable to the cash value feature calculated to permit an enhanced repair to the damaged component of the building.

13. The method of claim 10, wherein said loss event resulted from a peril excluded from coverage by the insurance policy, and said payment of said amount payable attributable to the cash value feature at least partly covers the incurred damage amount.

14. The method of claim 10, wherein said payment of said amount payable attributable to the cash value feature at least partly covers an excess of the incurred damage amount over an applicable coverage limit defined in the insurance policy.

15. The method of claim 9, wherein said insurance claim is placed under said cash value feature in respect to preventive maintenance or loss-resistance enhancement for an item of property covered by the insurance policy.

16. The method of claim 15, wherein said item of property is a building or a motor vehicle.

17. A computer system for processing data relating to insurance claims relating to a plurality of property and/or casualty insurance policies, at least some of the insurance policies each having a respective cash value feature associated therewith, the system comprising:
a data storage device configured to:
receive, store and provide access to insurance coverage data, wherein the insurance coverage data includes coverage amounts for said insurance policies, and currently funded monetary values for the cash value features associated with said at least some of the insurance policies;
one or more memories configured to:
store program instructions;
one or more computer processors coupled to the data storage device and the one or more memories, wherein said one or more computer processors, upon execution of the program instructions, are configured to:
receive information about an insurance claim associated with one of said at least some of the insurance policies;
a communication device, coupled to the one or more computer processors, configured to:
receive input information indicative of said insurance claim and forward said input information to the one or more computer processors;
wherein said one or more computer processors, upon execution of the program instructions, are further configured to:
determine if the insurance claim is covered by the cash value feature associated with said one of said at least some insurance policies;
determine the currently funded monetary value for said cash value feature;
determine an amount payable to a holder of said one of said at least some insurance policies and attributable to said cash value feature; and
facilitate payment of said amount payable attributable to the cash value feature.

18. The system of claim 17, wherein the one or more computer processors, upon execution of the program instructions, are further configured to determine, based on said input information, an incurred damage amount associated with a loss event.

19. The system of claim 18, wherein the one or more computer processors, upon execution of the program instructions, are further configured to facilitate payment of the incurred damage amount associated with the loss event, with the amount payable attributable to the cash value feature off-setting a deductible amount defined in said one of said at least some insurance policies.

20. The system of claim 18, wherein:
the loss event resulted in damage to a component of a building covered by said one of said at least some insurance policies; and
the one or more computer processors, upon execution of the program instructions, are further configured to facilitate payment of a further amount in addition to said amount attributable to the cash value feature, said further amount equal to said determined incurred damage amount less a deductible amount defined in said one of said at least some insurance policies, the amount payable attributable to the cash value feature calculated to permit an enhanced repair to the damaged component of the building.

21. The system of claim 18, wherein said loss event resulted from a peril excluded from coverage by said one of said at least some insurance policies, and said payment of said amount payable attributable to the cash value feature at least partly covers the incurred damage amount.

22. The system of claim 18, wherein said payment of said amount payable attributable to the cash value feature at least partly covers an excess of the incurred damage amount over an applicable coverage limit defined in the insurance policy.

23. The system of claim 17, wherein said insurance claim is placed under said cash value feature in respect to preventive maintenance or loss-resistance enhancement for an item of property covered by the insurance policy.

24. The system of claim 23, wherein said item of property is a building or a motor vehicle.
